(19) United States
(12) Patent Application Publication
(10) Pub. No.: US 2013/0220002 A1
(43) Pub. Date: Aug. 29, 2013

(54) MEMBRANE SEPARATION APPARATUS, MEMBRANE SEPARATION APPARATUS OPERATION METHOD, AND EVALUATION METHOD USING THE MEMBRANE SEPARATION APPARATUS

(71) Applicants: Kentarou Kobayashi, Osaka (JP); Takahisa Konishi, Osaka (JP); Makoto Kobuke, Osaka (JP); Kouji Maruyama, Osaka (JP); Makiko Namba, Osaka (JP)

(72) Inventors: Kentarou Kobayashi, Osaka (JP); Takahisa Konishi, Osaka (JP); Makoto Kobuke, Osaka (JP); Kouji Maruyama, Osaka (JP); Makiko Namba, Osaka (JP)

(73) Assignee: NITTO DENKO CORPORATION, Ibaraki-shi, Osaka (JP)

(21) Appl. No.: 13/879,732

(22) PCT Filed: Oct. 21, 2011
(86) PCT No.: PCT/JP2011/005914

§ 371 Date: Apr. 16, 2013

(30) Foreign Application Priority Data
Oct. 21, 2010 (JP) 2010-236212

(51) Int. Cl. B01D 65/10; G01N 17/00

(52) U.S. Cl. CPC B01D 65/10; G01N 17/008
USPC 73/61.62; 210/321.6

(57) ABSTRACT

A submodule is used to know exactly fouling of a membrane surface in a separation membrane module. The membrane separation apparatus of the present invention includes: a separation membrane module (1) configured to produce at least a permeate fluid from a feed fluid; and at least one submodule (2) having a separation membrane (23) made of the same material as a separation membrane in the separation membrane module (1). A deposition member (22) is provided on a surface of the separation membrane (23) in the submodule (2), and the feed fluid is supplied onto the surface.

### TECHNICAL FIELD

The present invention relates to a membrane separation apparatus including a separation membrane module (hereinafter also referred to as an operation module) provided with a separation membrane for obtaining at least a permeate fluid from a feed fluid, and a sub-module for evaluating the membrane surface (for evaluating the surface of its separation membrane). The present invention also relates to an operation method of this apparatus, and an evaluation method using this apparatus.

### BACKGROUND ART

A membrane separation apparatus has a separation membrane such as a reverse osmosis membrane or an ultrafiltration membrane, and is capable of straining and filtering (membrane-separating) various fluids such as liquids and gases by the membrane separating action of the separation membrane. For example, the use of a reverse osmosis membrane apparatus makes it is possible to desalinate brackish water or seawater to obtain fresh water, or to produce pure water or ultrapure water from water for industrial use (see, for example, Patent Literature 1).

In such a membrane separation apparatus, organic substances, inorganic substances, bacteria, etc. in the fluid are deposited to form scales or biofilms on the surface of a separation membrane (hereinafter also referred to as a membrane surface) with time. Such deposits foul the membrane surface and may degrade the membrane performance (membrane separating action of the separation membrane). Cleaning of the separation membrane is effective in solving this problem. Conventionally, chemical cleaning using an alkaline solution, etc. or physical cleaning such as reverse cleaning in which a feed fluid is passed in the direction opposite to the fluid flow direction during the operation is performed based on experience, fluid data before and after the membrane separation, etc. In recent years, it has been proposed to provide a small submodule outside an operation system separately from an operation module. The membrane surface state in this submodule is monitored to know the membrane surface state in the operation module without stopping the operation module, and based on this state, the timing of physical cleaning or chemical cleaning of the separation membrane in the operation module is determined (see, for example, Patent Literatures 1 to 3). In such a case as the membrane separating action of the separation membrane in the operation module is not sufficiently recovered by the cleaning of the membrane, the separation membrane is sometimes replaced.

However, it is difficult to know the membrane surface state well (in particular, formation of biofilms of bacteria on the membrane surface) in the operation module by monitoring the membrane surface state in the submodule. That is, it is difficult to determine the appropriate timing of cleaning and replacement by using the submodule.

### CITATION LIST

### Patent Literature

Patent Literature 1 JP 2008-253953 A
Patent Literature 2 JP 10 (1998)-286445 A
Patent Literature 3 JP 2009-524521 T

### SUMMARY OF INVENTION

### Technical Problem

It is an object of the present invention to provide a membrane separation apparatus having a separation membrane module and a submodule that is provided separately from the separation membrane module to monitor the membrane surface state of a separation membrane, so that the submodule is used to know exactly fouling of the membrane surface in the separation membrane module. It is another object of the present invention to provide a membrane separation apparatus operation method for stable operation of the separation membrane module, and an evaluation method using the membrane separation apparatus.

### Solution to Problem

The present invention provides a membrane separation apparatus including: a separation membrane module configured to produce at least a permeate fluid from a feed fluid; and at least one submodule including a separation membrane made of the same material as a separation membrane in the separation membrane module. A deposition member is provided on a surface of the separation membrane in the submodule, and the feed fluid is supplied onto the surface.

It is preferable that the membrane separation apparatus include a means of measuring an intensity of light reflected from the submodule. The measurement of the reflected light intensity allows the details, such as the thickness, amount, type, etc., of deposits on the membrane surface (deposits on the surface of the separation membrane in the submodule) to be estimated.

It is preferable that the deposition member include projections that are in contact with the surface of the separation membrane in the submodule and have a thickness of 0.1 mm or more in a thickness direction of the separation membrane in the submodule. The deposition member may be a mesh net that entirely covers the surface of the separation membrane in the submodule.

In another aspect, the present invention provides an operation method of the membrane separation apparatus according to the present invention. The method includes accumulating, analyzing, or transmitting and receiving electronic data by using an electronic means. The electronic data is obtained from an imaging system or a data acquisition system provided in the submodule. In still another aspect, the present invention provides an evaluation method using the membrane separation apparatus according to the present invention. The method includes comparatively evaluating fouling in a region adjacent to the deposition member on the surface of the separation membrane in the submodule and fouling in a region other than the adjacent region on the surface in the submodule.

### Advantageous Effects of Invention

The deposition member is provided in the submodule of the present invention. With the use of this submodule, it is easy to see the membrane fouling state in the separation membrane module. That is, the membrane separation apparatus of the present invention makes it possible to accurately determine the appropriate timing of cleaning and replacement of the separation membrane module. The electronic data obtained from the imaging system or the data acquisition system provided in the submodule is useful to know the membrane fouling state in a number of operation modules and determine the timing of cleaning and replacement of the separation membranes in the operation modules. Furthermore, such a use of the membrane separation apparatus for comparative evaluation of the region adjacent to the deposition member and the region other than the adjacent region on the surface of the separation membrane in the submodule is effective to know the membrane fouling state in the operation module.

### BRIEF DESCRIPTION OF DRAWINGS

FIG. 1 is a configuration diagram showing one example of a membrane separation apparatus of the present invention.

FIG. 2 is a cross-sectional view showing one example of the structure of a submodule of the present invention.

FIG. 3 is a perspective view of the submodule of FIG. 2.

FIG. 4 is a cross-sectional view showing another example of the structure of the submodule of the present invention.

FIG. 5 is a schematic configuration diagram showing one example of a measurement system of the membrane separation apparatus of the present invention in which a reflection-type confocal optical system is used.

FIG. 6 is an enlarged view showing the relationship between a deposition member and points for observation of a membrane fouling state.

FIG. 7A is a photograph showing the membrane fouling state in the submodule of the present invention.

FIG. 7B is a photograph showing the membrane fouling state in a submodule without a deposition member.

FIG. 8 is a chart of visualized distribution of spectra near 1040 cm⁻¹ on the surface of the separation membrane in the submodule of the present invention.

FIG. 9 is a graph showing a time-dependent change in permeate flux in the submodule of the present invention, a time-dependent change in permeate flux in the submodule without a deposition member, and a time-dependent change in permeate flux in the operation module.

### DESCRIPTION OF EMBODIMENTS

The membrane separation apparatus according to the present invention includes: a separation membrane module configured to produce at least a permeate fluid from a feed fluid; and a submodule including a separation membrane made of the same material as a separation membrane used in the separation membrane module. A deposition member is provided on a surface of the separation membrane in the submodule, and the feed fluid is supplied onto the surface. In the following description, the separation membrane module is also referred to as an operation module. The surface of the separation membrane in the separation membrane module or the submodule is also referred to as a membrane surface.

In the present invention, the feed fluid supplied to the separation membrane module is not particularly limited, and examples of the feed fluid include liquids, gasses, and vapors. When the membrane surface is likely to be fouled because the feed fluid contains many substances that may cause fouling, the effect that the membrane fouling state can be checked (as will be described in detail hereinafter) becomes more pronounced. In view of this, the present invention is suitable for treatment of water, as the feed fluid, such as brackish water, seawater, waste water, and industrial water. Examples of substances that cause membrane fouling include suspended substances such as fine particles and microorganisms, oxides of metals such as iron and manganese, insoluble inorganic substances (scales) such as calcium carbonate and silica, and organic substances such as oils and polymer residues. In particular, the formation and growth of biofilms developed by deposition of microorganisms such as bacteria depend on the membrane surface state and the conditions of the fluid. Therefore, given that it is difficult for conventional techniques to predict how the biofilms will form and grow, the effect of the present invention that the overall membrane fouling state including the state of the membrane fouled with biofilms can be checked becomes more pronounced in an environment in which biofilms are likely to form and grow.

The filtration method used in the separation membrane module and the submodule are not limited. Examples of the filtration method include dead-end filtration in which almost all of a feed fluid is filtered into a permeate fluid and no concentrated fluid is produced, and cross-flow filtration in which a feed fluid is separated into a permeate fluid and a concentrated fluid. However, it is preferable for the submodule to use the same filtration method as used in the separation membrane module in order to reproduce the situation of the separation membrane module in the submodule.

The separation membranes used in the separation membrane module and the submodule are not limited as long as they can membrane-separate a feed fluid. Examples of the separation membrane include a reverse osmosis (RO) membrane, a nanofiltration (NF) membrane, an ultrafiltration (UF) membrane, and a microfiltration (MF) membrane. However, when biofilms are likely to form on the surfaces of the membranes onto which the feed fluid is supplied in the separation membrane module and the submodule, that is, when microorganisms are less likely to pass through the membranes, the effect that the fouling of the membranes can be checked becomes more pronounced. From this viewpoint, the present invention is more suitable for the use of a separation membrane with an average pore size of 1 μm or less, specifically, an RO membrane, an NF membrane, or an UF membrane.

For example, there is no particular limitation on the type of reverse osmosis membranes that can be used for water treatment, and any known reverse osmosis membranes can be used. Examples of materials of reverse osmosis membranes for water treatment include various polymeric materials such as cellulose acetate, polyvinyl alcohol, polyamide, and polyester. The reverse osmosis membrane may be a composite membrane made of any combination of these materials laminated together. For example, a composite reverse osmosis membrane that can be used as the reverse osmosis membrane is composed of a nonwoven fabric substrate, a microporous layer such as a polysulfone layer formed thereon, and a separation functional layer formed on the surface of the microporous layer by interfacially polymerizing a polyamide resin on the microporous layer.

As the separation membrane module, any type of module may be used. For example, the separation membrane module is a flat type such as a frame-and-plate type, a tubular type, a hollow fiber type, a spiral type, or a pleated type module (in a spiral type separation membrane module (reverse osmosis membrane module), one or a plurality of modules are usually loaded in a pressure vessel, but a pressure vessel-integrated separation membrane module may be used as a spiral type separation membrane module). However, it is preferable to use a flat type (flat shape) submodule in terms of visibility of the separation membrane in the submodule and ease of placement of the deposition member. In view of this, flat type, spiral type, and pleated type separation membrane modules are suitable for the present invention because the membrane fouling state in these separation membrane modules can be reproduced more accurately in the flat type submodule.

The location of the submodule is not particularly limited as long as any of the feed fluid, the concentrated fluid, and the permeate fluid in the operation module can be supplied to the submodule and the state of the separation membrane can be monitored without any adverse effect on the operation module. For example, in order to see the membrane fouling state in the operation module and determine the cleaning timing and replacement timing, it is preferable to place the submodule at the location where the feed fluid composed of the same components as the feed fluid supplied to the separation membrane module can be supplied to the submodule under approximately the same conditions (such as a pressure). In order to analyze biofilms, etc. formed in the submodule, it is preferable to place the submodule at the location where the concentrated fluid drained from the separation membrane module can be supplied to the submodule. The number of submodules placed may be one or two or more. A valve (supply pressure regulating valve), a pressure pump, or the like may be provided to regulate the amount, pressure, etc. of the fluid to be supplied to the submodule.

In the submodule of the present invention, a deposition member is provided on the fluid supply side surface of the flat separation membrane (onto which the feed fluid is supplied). In the present embodiment, the deposition member is in contact with the separation membrane. Any deposition member may be used as long as it can once block the flow of the feed fluid to cause the feed fluid to accumulate or produce a turbulent flow of the feed fluid in the submodule, and partially or entirely covers the membrane surface. The deposition member may include projections formed on the surface of the separation membrane, and the shape of the projections is not limited. For example, in order to reflect the membrane surface state in the operation module, it is preferable that the projections be in the form of a mesh net and the mesh net entirely cover the membrane surface. This configuration makes it possible to consider the membrane surface state in each cell of the mesh net as a function of the distance from the wall of the mesh net and to see the membrane surface state more comprehensively. Furthermore, when a flow path member having the same shape as a feed-side flow path member used in the operation module is used as the deposition member (when the deposition member has the same shape as the feed-side flow path member), the membrane surface state can be obtained more accurately. In this case, if a cleaning experiment is performed beforehand in the submodule, the cleaning effect in the operation module can be assessed easily. That is, the use of such a deposition member makes it possible to reproduce about the same level of fouling as in the operation module (the fouling state of the fluid supply side surface of the separation membrane in the operation module).

The method for placing the deposition member on the membrane surface is not particularly limited. Examples of the method include a method of bonding the deposition member onto the membrane surface, and a method of sandwiching the deposition member between parts of the frame of the submodule at two or more positions so as to fix it to the membrane surface. In particular, in order to provide the deposition member to cover the membrane surface entirely, it is preferable to fix the separation membrane and the deposition member having almost the same size as the separation membrane together with the frame.

The material of the deposition member is not particularly limited, and examples of the material include resins and metals. Examples of the material include resins such as polypropylene (PP), polyethylene (PE), polyethylene terephthalate (PET) and polyamide (PA), natural polymers, and rubbers. A resin deposition member, in particular, a polypropylene deposition member is preferred because it is resistant to corrosion, degradation and deformation in the fluid. The shape of the deposition member also is not particularly limited as long as it produces an appropriate turbulent flow of the feed fluid or causes the feed fluid to accumulate appropriately in the submodule as described above. The mesh net is a simple form of the deposition member. The mesh net can be placed to cover the entire surface of the separation membrane. In particular, it is preferable to use, as the material of the deposition member, the same material as that of the feed-side flow path member used in the separation membrane module because the flow of the feed fluid in the separation membrane module can be reproduced more accurately in the submodule. The dimensions of the deposition member are not particularly limited. The thickness of the deposition member in the thickness direction of the separation membrane in the submodule is, for example, 0.1 mm or more and 5 mm or less, and preferably 0.3 mm or more and 2 mm or less. An excessively thick deposition member is not preferred because its effect of blocking the flow path becomes too strong and thus fouling may be localized in a part of the membrane surface in such a manner that the fluid easily reaches a region of the separation member but it hardly reaches another region thereof, resulting in a significant difference between the membrane surface state obtained with the use of the deposition member and that obtained without the use of the deposition member. An excessively thin deposition member also is not preferred because the effect of the turbulent flow and accumulation of the fluid in the flow path of the submodule becomes insufficient, resulting in a significant difference between the membrane surface state in the operation module and that in the submodule.

The submodule of the present invention only has to include a feed fluid inlet, a permeate fluid outlet, a separation membrane, a deposition member on the separation membrane, and a vessel containing them. Preferably, the vessel has a pressure-resistant closed space. A permeate-side flow path member may be provided between the permeate fluid outlet and the separation membrane. However, when a cross-flow type submodule is used, a concentrated fluid outlet is required. Preferably, the submodule has a pressure-resistant structure capable of withstanding the supply pressure of the fluid. From this viewpoint, it is preferable to close the flow path in the submodule by sealing the joints between the constituent components of the submodule and the joints between the submodule and other devices with O-rings or the like. The pressure that could be generated in the submodule is, for example, about 0.1 to 10 MP, although it depends on the fluid and the separation membrane, and when the submodule is used for desalination of seawater, the pressure therein is about 1.5 to 10 MPa. That is, it is preferable to configure the submodule to withstand a pressure of about 10 MPa.

In order to assess the effect obtained by applying the submodule of the present invention to a water treatment system, etc., it is preferable that an evaluation means capable of evaluating the membrane fouling state in the submodule be provided therein. The evaluation means is, for example, a means capable of making evaluations such as direct visual or microscopic observation, image-taking, and acquisition of data other than image data. Particularly in the present invention, it is preferable to use an evaluation means of measuring the intensity of light reflected from the membrane surface in the submodule. Since the use of the evaluation means of measuring the intensity of the reflected light makes it easier to evaluate bacteria biofilms without staining the biofilms, the accuracy of the evaluation can be increased. Such an evaluation means is, for example, a reflection-type confocal optical device. The reflection-type confocal optical device can be easily used under various conditions by calibrating an incident light source, reflection conditions of a half mirror, etc. and a detector of a light receiving portion of a light receiving element.

Examples of the direct visual or microscopic observation of the membrane fouling state in the submodule include batch observation in which the flow of the feed fluid into the submodule is temporarily stopped to observe the membrane surface in batch mode, and in-line observation in which a vessel partially or entirely made of a transparent material is used to observe the membrane surface in in-line mode. In both of the observations, a visualizing agent such as a dye may be injected into the submodule to allow the membrane fouling state to be visually identified. In the in-line observation, the membrane fouling state in the operation module can be obtained in real time based on the observation of the membrane fouling state in the submodule. Examples of microscopes suitably used for observation of the membrane fouling state in the submodule include a confocal optical microscope such as the above-mentioned reflection-type confocal optical microscope, a fluorescence microscope, and a laser microscope.

The dye and the method of adding the dye are not limited to a commercially available substance and a known method, respectively. The dye to be used and the detection method to be adopted can be selected appropriately depending on a substance to be identified (a substance to be stained). Examples of the dye for organic substances include toluidine blue and alcian blue (both from Wako Pure Chemical Industries, Ltd.). As dyes for inorganic substances, dyes or the like having adsorptivity to the respective substances can be used. Examples of dyes for bacteria include 2,3,5-triphenyltetrazolium chloride, 4′, 6-diamidino-2-phenylindole (DAPI), and propidium iodide (PI). Instead of dyes, enzyme substrates or the like also may be used for these bacteria to cause them to develop colors or emit light. Thus the species of the bacteria can also be identified. In addition to the use of a dye to evaluate the membrane fouling caused by organic substances, a spectrocolorimeter or a spectrophotometer can also be used to measure the light reflected from the membrane surface in the submodule (as will be described in detail hereinafter) so as to evaluate the membrane fouling comprehensively. Thereby, the distributions and proportions of components derived from the organic substances in the deposits that could cause membrane fouling can be observed.

The dye is supplied from a dye storage tank to the feed fluid inlet by a pump, for example. The dye can be injected at an arbitrary timing, and it may be added continuously or intermittently, or may be added only when something abnormal occurs.

When the separation membrane in the submodule is observed in in-line mode, it is possible to use the vessel partially made of a transparent material. For example, it is possible to mount a member made of a transparent material (transparent window) on the vessel body (submodule outer wall). In this case, the transparent window can be provided so as to face the surface of the separation membrane onto which the feed fluid is supplied in the submodule.

The specific configuration of the vessel partially made of a transparent material is not particularly limited. The transparent window can be mounted in a removable manner on the submodule outer wall. This transparent window allows in-line observation of the membrane surface in the submodule. This transparent window can also be removed to allow microscopic observation of the membrane surface in the submodule by using a microscope with an immersion lens. With the use of this type of microscope, correction of lens aberration caused by the transparent window can be omitted.

The transparent window is mounted on the submodule outer wall by a technique such as screwing, sliding, or fitting. When the transparent window is mounted by screwing, for example, a female screw portion and a male screw portions are formed on the submodule outer wall and the transparent window, respectively. It is preferable that the submodule outer wall and the male screw portion of the transparent window be flush with each other inside the submodule outer wall when the male and female screw portions are engaged. When the transparent window is mounted by sliding, for example, an opening into which the transparent window can be inserted (for example, an opening that opens in the direction along the separation membrane) is formed in the submodule outer wall so as to insert the transparent window into the opening. Furthermore, a motor may be provided in the submodule to supply power for inserting the transparent window. When the transparent window is mounted by fitting, for example, an opening into which the transparent window can be fitted (for example, an opening that opens in the direction perpendicular to the separation membrane) is formed in the submodule outer wall so as to fit the transparent window into this opening.

The submodule may have a plurality of transparent windows. For example, it is possible to provide a transparent window on the feed fluid inlet side on the submodule outer wall and another transparent window on the side opposite to the feed fluid inlet side. Biofilms tend to be deposited on the feed fluid inlet side, while scales tend to be deposited on the side opposite to the feed fluid inlet side. Therefore, in this configuration, the biofilms can be well observed through the transparent window provided on the feed fluid inlet side, and the scales can be well observed through the transparent window provided on the side opposite to the feed fluid inlet side.

When the membrane surface is evaluated by taking images, it is possible, for example, to use a submodule that is partially or entirely made of a transparent material and a commercially available imaging system such as a camera or a video camera as an evaluation means. The imaging system may be a movable or stationary one.

When the imaging system is used in the present invention, it is preferable to connect a reflection-type confocal optical device such as a reflection-type confocal optical microscope to the imaging system. In this configuration, the injection of a dye into the separation membrane module can be omitted. Therefore, the membrane fouling state can be observed continuously without replacing the separation membrane in the submodule. In this configuration, biofilms can also be well detected (conventionally, it is difficult to detect biofilms without using a dye).

As the imaging system, for example, a combined system of any type of microscope and an image recorder and/or a real-time assessment device can be used preferably. In particular, when biofilms are observed in the present invention, the biofilms can be detected by a confocal imaging system such as a laser scanning confocal microscope, as described in JP 2005-525551 T.

Furthermore, as a data acquisition system for use as an evaluation means for acquiring data other than images, a system for measuring reflected light intensity using the reflection of ultrasonic waves, infrared radiation, or visible radiation and evaluating the membrane surface state, such as the contents or amount of deposits, can be used, for example. Examples of such a system include a system for identifying or inferring the type of deposits by measuring and comparing the intensities of reflections of incident white light at various wavelengths, and a system for measuring the presence or the thickness of deposits by measuring the intensity of reflection of incident monochromatic light such as laser light. Scanning and measurement of the membrane surface with such a system allows the information about deposits on the membrane surface to be obtained. In this case, it is preferable to use the data acquisition system in conjunction with a detection device for detecting and alarming abnormal values of data obtained by the data acquisition system so as to automate the detection of the presence of abnormality. The detection system can also be used in conjunction with the imaging system.

In order to make effective use of the present invention, it is preferable to set appropriate positions on the membrane surface in the submodule to be evaluated by the evaluation means. When the deposition member is used, biofilms or scales are likely to be deposited within a region surrounding the deposition member, with a width approximately equal to the thickness of the deposition member (for example, the width of the surrounding region is about 1 mm when the thickness of the deposition member is 1 mm) on the membrane surface. In particular, they are likely to be deposited on the side opposite to the fluid supply side of the deposition member. That is, the fouling and degradation of the membrane surface can be assessed at an early stage by the method of comparatively evaluating the surrounding region with a width approximately equal to the thickness of the deposition member on the membrane surface and a region other than that surrounding region on the membrane surface. In other words, the fouling and degradation of the separation membrane in the separation membrane module can be assessed at an early stage by comparing the fouling in a region adjacent to the deposition member on the surface of the separation membrane onto which the feed fluid is supplied in the submodule (for example, the region surrounding the deposition member, with a width approximately equal to the height of the deposition member) with the fouling in a region other than the region adjacent to the deposition member on that surface.

More specifically, the surface of the separation membrane onto which the feed fluid is supplied in the submodule is divided into a covered region covered by the deposition member and an adjacent region surrounding and adjacent to the covered region, and the adjacent region is further divided into a fluid supply side adjacent region on the fluid supply side of the covered region and an opposite adjacent region on the side opposite to the fluid supply side with respect to the covered region. In this case, the fouling and degradation of the separation membrane in the separation membrane module can be assessed at an early stage by comparing the amount of deposits per unit area in the fluid supply side adjacent region and the amount of deposits per unit area in the opposite adjacent region. It is further preferable to compare the amount of deposits per unit area in the fluid supply side adjacent region and the amount of deposits within a region with a distance equal to the height of the deposition member from the deposition member in the opposite adjacent region. Furthermore, it is preferable that the membrane separation apparatus include a distribution evaluation system capable of making these comparisons.

From another aspect, the fouling and degradation of the separation membrane in the separation membrane module can be assessed at an early stage by an evaluation method using a membrane separation apparatus including the above-mentioned distribution evaluation system. This evaluation method includes the steps of membrane-separating the fluid by the separation membrane in the separation membrane module and the separation membrane in the submodule; and evaluating fouling of the separation membrane in the submodule by the distribution evaluation system.

Electronic data obtained from the imaging system or the data acquisition system provided in the submodule may be accumulated, analyzed, or sent to and received from a predetermined management storage through an electronic means such as a computer or a transmitting/receiving device. This allows not only easy accumulation of data but also appropriate and accurate real-time assessment.

For example, electronic data can easily be accumulated when the membrane separation apparatus includes an accumulating device for accumulating electronic data. The membrane fouling state can be analyzed in real time when the membrane separation apparatus includes an analyzing device for analyzing electronic data. The membrane fouling state can be evaluated by an external device when the membrane separation apparatus includes a transmitting/receiving device for transmitting and receiving electronic data. That is, it is preferable that the membrane separation apparatus include an electronic data creating device for creating electronic data obtained from the imaging system or the data acquisition system provided in the submodule, and further include at least one selected from an accumulating device for accumulating the electronic data, an analyzing device for analyzing the electronic data, and a transmitting/receiving device for transmitting and receiving the electronic data. The analyzing device may have the distribution evaluation system.

From another aspect, it is preferable to perform an operation method of the membrane separation apparatus including the above devices. This operation method includes the steps of membrane-separating the fluid by the separation membrane in the separation membrane module and the separation membrane in the submodule; and creating electronic data of the membrane fouling state on the surface of the separation membrane onto which the feed fluid is supplied in the submodule by means of the imaging system or the data acquisition system. This operation method further includes at least one selected from the steps of: accumulating the electronic data by the accumulating device, analyzing the electronic data by the analyzing device, and transmitting and receiving the electronic data to and from the transmitting/receiving device.

Hereinafter, an example in which a reverse osmosis membrane module is used as a separation membrane module is described with reference to the drawings, but the present invention is not limited to this example.

### EXAMPLES

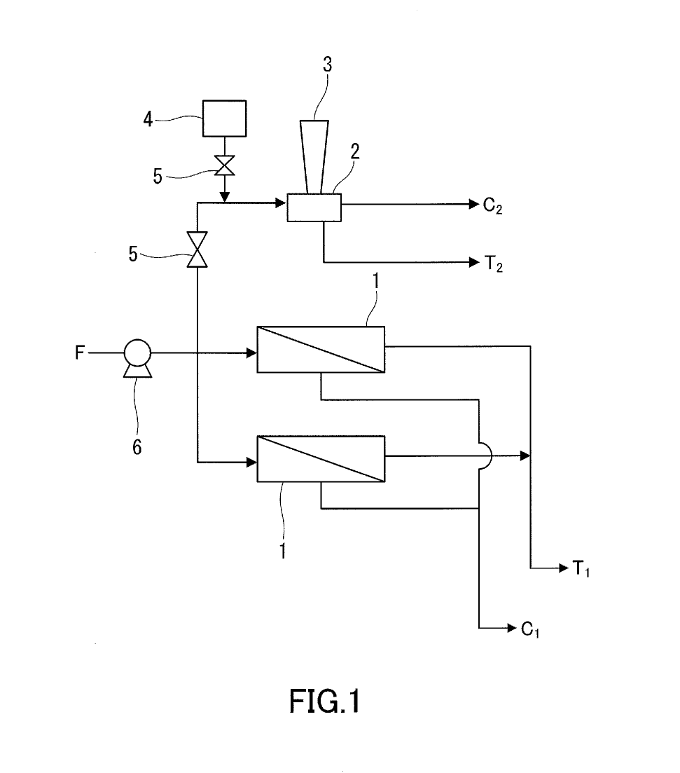

In the example, a membrane separation apparatus was configured as shown in FIG. 1. In this membrane separation apparatus, a portion (large portion) of feed water F is introduced into a reverse osmosis membrane module (separation membrane module) 1 along a flow path, and separated into permeate water T₁ and concentrated water C₁ by membrane separation. Another portion (small portion) of the feed water F is introduced into a submodule 2, and separated into permeate water T₂ and concentrated water C₂ by membrane separation. A pressure pump 6 for creating a flow of the feed water F and a valve (supply pressure regulating valve) 5 for regulating the flow (flow rate, pressure, etc.) of the feed water F introduced into the submodule 2 were provided in the flow path in the membrane separation apparatus.

As the reverse osmosis membrane module 1, a cross-flow filtration module including seven serially connected spiral RO membrane elements ES20 (Nitto Denko Corporation) loaded in a pressure vessel was used. A reverse osmosis membrane in ES20 is a composite reverse osmosis membrane having a separation functional layer obtained by forming a microporous polysulfone layer on a PET nonwoven fabric substrate and interfacially polymerizing a solution containing m-phenylenediamine and trimesic acid chloride as main components on the surface of the microporous layer. This composite reverse osmosis membrane is laminated with a permeate-side flow path member and a feed-side flow path member, and this laminate is spirally wound around a perforated hollow tube and is fixed by end members and an outer housing to form a spiral RO membrane element.

As the feed water F, water that had been pretreated sufficiently for the treatment by the reverse osmosis membrane was used. Specifically, experimental wastewater used was obtained by putting a drainage filter used in a food processing plant into a pure water tank and incubating the water at room temperature for one week. The total cell number of microorganisms contained in this experimental wastewater was 5×10⁴ cell/ml, and the viable cell number thereof was 3×10⁴ cell/ml. This experimental wastewater was supplied as the feed water F to the reverse osmosis membrane module 1 and the submodule 2 at a pressure of 1.5 MPa applied by the pressure pump 6. The on-off valve 5 was used to control the supply of the experimental wastewater to the submodule.

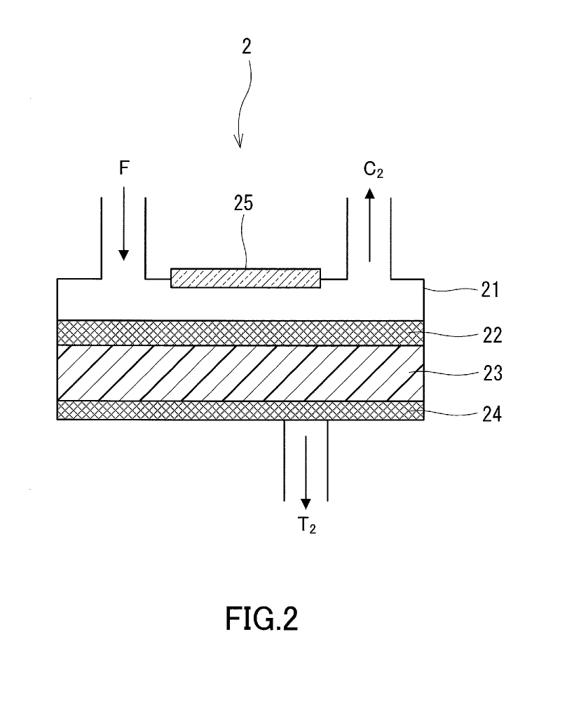

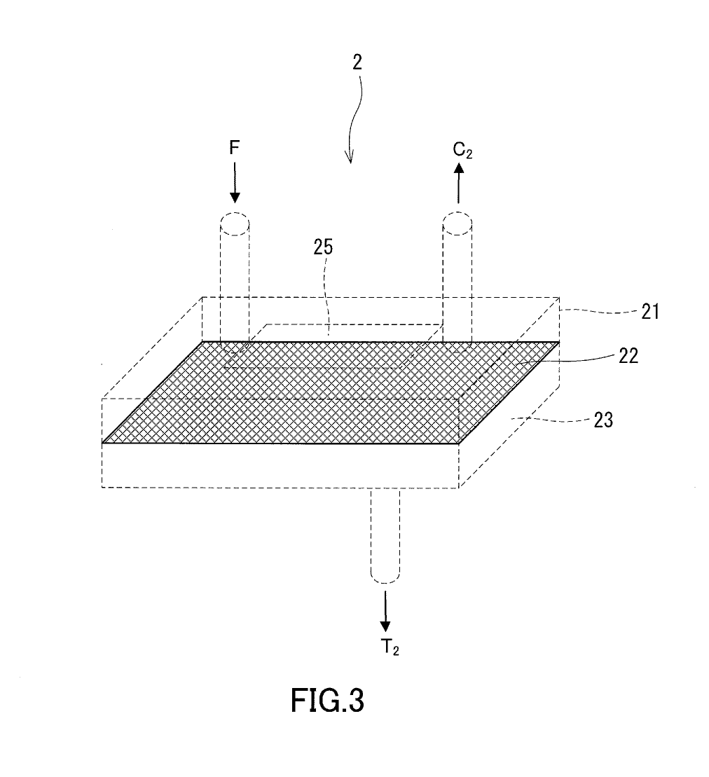

As the submodule 2, a module shown in FIG. 2 or FIG. 3 was produced (a permeate-side flow path member 24 is omitted in FIG. 3 for readability). The submodule outer wall 21 was formed of an acrylic resin and an O-ring made of silicone rubber. A deposition member 22, a reverse osmosis membrane 23, and a permeate-side flow path member 24 were laminated together and contained in the submodule outer wall 21. As the reverse osmosis membrane 23, the same membrane as the composite reverse osmosis membrane in the reverse osmosis membrane module 1 was used and placed so that a separation functional layer faces the deposition member 22. As the permeate-side flow path member 24, the same flow path member as the permeate-side flow path member in the reverse osmosis membrane module 1 was used. As the deposition member 22, the same net as a polypropylene mesh net (with an intersection angle of 90°, an inter-intersection distance of 4 mm, and a thickness of 0.9 mm) serving as the feed-side flow path member used in the reverse osmosis membrane module was used. A transparent window 25 was provided on the upper surface of the submodule outer wall 21. An imaging system 3 in which a digital video camera was connected to a reflection-type confocal optical microscope (LSM 700, Carl Zeiss) was placed at a position where membrane fouling could be observed through the transparent window 25.

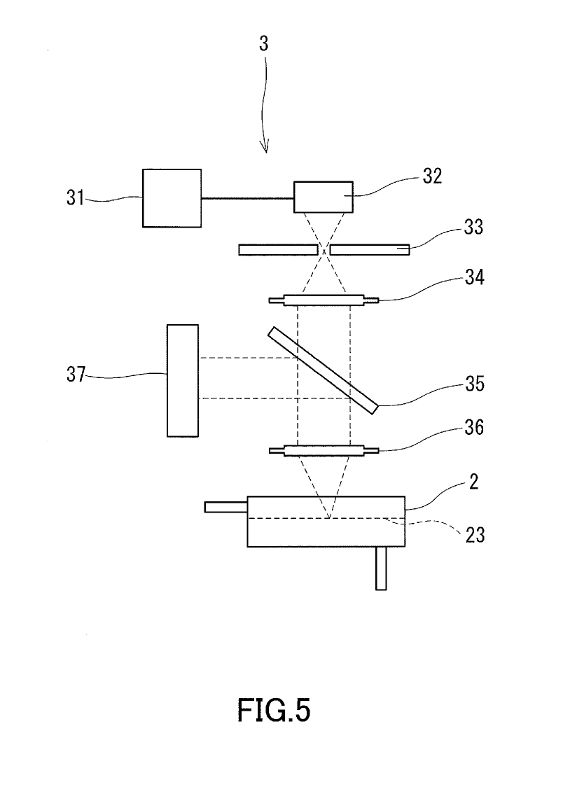

FIG. 5 shows an optical system (reflection-type confocal optical system) in this example in which the imaging system 3 was connected to the submodule 2. Light emitted from a light source 37 is reflected at a half mirror 35 in the direction toward the submodule 2, passes through an objective lens 36, and focuses on the surface of the reverse osmosis membrane 23 (to be precise, on the deposits on the reverse osmosis membrane 23) to form the image thereof. The image reflected from the surface of the reverse osmosis membrane 23 passes through the objective lens 36 and the half mirror 35 and then through an image formation lens 34 and a pinhole panel 33, and reaches a light receiving element 32. Thus, the image data of the deposits can be obtained. In this example, this image data was analyzed with an image processor 31 connected to the light receiving element 32.

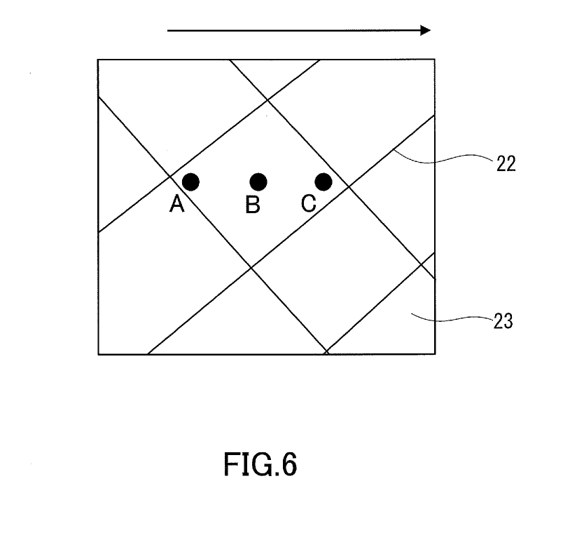

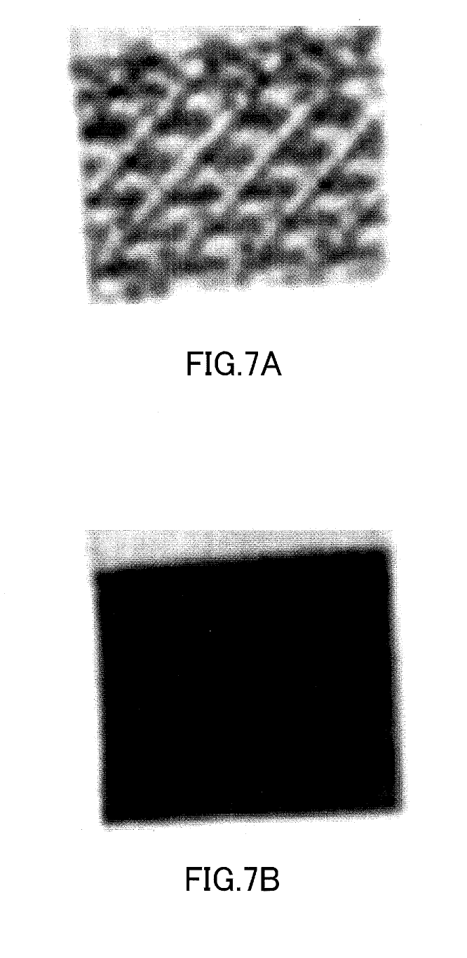

More specifically, the deposits at three points A, B and C shown in FIG. 6 were observed with the imaging system 3. Point A is located at a distance of 0.5 mm from the nearest part of the deposition member on the side closer to the feed water inlet (at a distance of 0.5 mm in the flow direction of the experimental wastewater from the intersection of the mesh net). In contrast, Point C is located at a distance of 0.5 mm from the nearest part of the deposition member on the side farther from the feed water inlet (at a distance of 0.5 mm in the direction opposite to the flow direction of the experimental wastewater from the intersection of the mesh net). Point B is located far from any part of the deposition member. An arrow in FIG. 6 indicates the flow direction of the experimental wastewater. FIG. 7A shows a photograph of the surface of the reverse osmosis membrane and the deposits thereon one week after the activation of the membrane separation apparatus. As shown in FIG. 7A, large deposits of probably biofilms were observed at Point A, while smaller deposits were observed at Points B and C. An experiment using a submodule without a deposition member was conducted in the same manner and an image was taken in the same manner. FIG. 7B shows the image taken. FIG. 7B reveals that biofilms are deposited uniformly on the entire surface of the membrane.

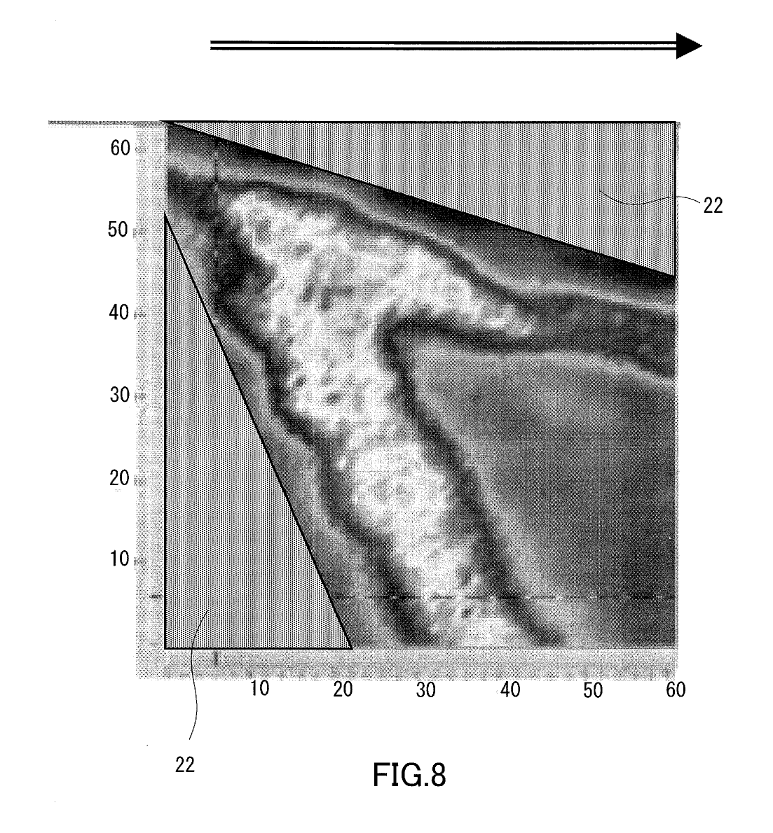

Next, a FT-IR spectrometer (FTS-7000S, Varian) for FT-IR measurement was used to observe the deposits on the reverse osmosis membrane 23 two weeks after the activation of the membrane separation apparatus. Specifically, spectra near 1040 cm⁻¹ obtained by FT-IR measurement of the deposits on the reverse osmosis membrane 23 were subjected to image processing for visualization. FIG. 8 shows an enlarged image (2.5 mm square) of the distribution near the deposition member. In the FT-IR measurement, the spectra near 1040 cm⁻¹ are derived from polysaccharides. This means that FIG. 8 shows the amount of deposited fouling bacteria as a distribution of colors (shades of colors). FIG. 8 reveals that the fouling bacteria are distributed on the side opposite to the fluid supply side with respect to the wall of the deposition member. An arrow in FIG. 8 indicates the flow direction of the experimental wastewater.

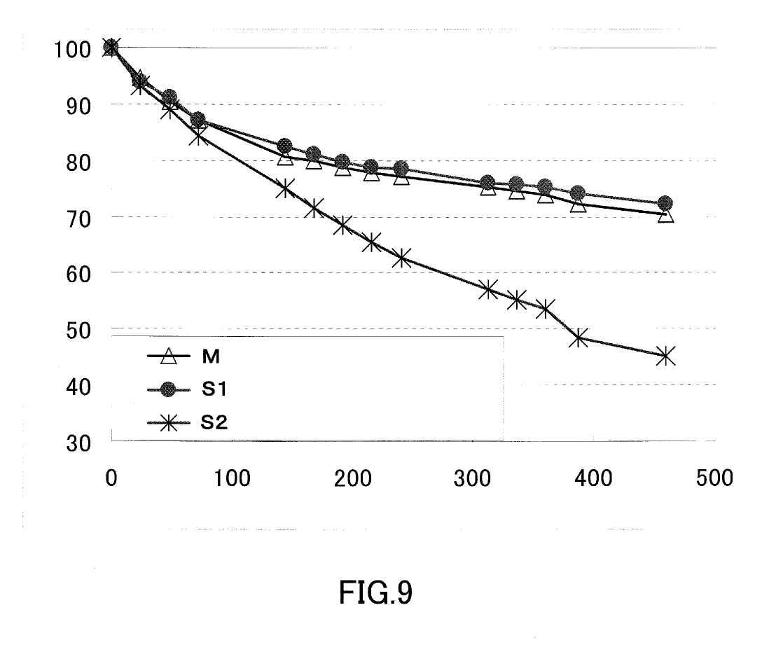

For each of the submodule 2 having the deposition member 23, a submodule without the deposition member 23, and the reverse osmosis membrane module 1, the permeation flux retention rate (permeation flux at a time t/initial permeation flux (time=0)×100) was measured. FIG. 9 is a graph showing the time-dependent change in the flux retention rates (the horizontal axis is the elapsed time (h) and the vertical axis is the flux retention rate (%)). FIG. 9 reveals that the rate of decrease in the flux retention rate S2 (a decrease in flux retention rate/elapsed time) of the submodule without the deposition member 23 was as high as 1.8 times or more the rate of decrease in the flux retention rate M of the reverse osmosis module 1. On the other hand, the rate of decrease in the flux retention rate S1 of the submodule 2 having the deposition member 23 was 1.1 times or less the rate of decrease in the flux retention rate M of the reverse osmosis membrane module 1. From these results, it is inferred that the submodule of the present invention has high reproducibility of the membrane surface in the operation module.

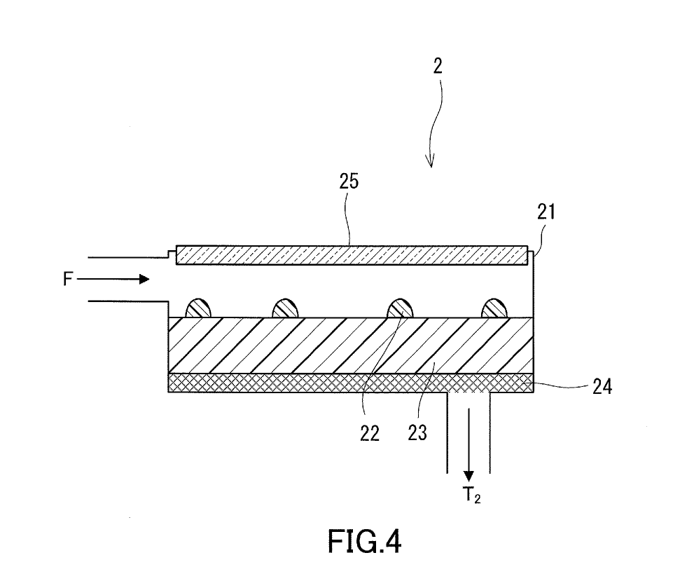

Based on the results of this example, it is expected that the use of the dead-end type submodule 2 having the deposition member 22 provided discontinuously, as shown in FIG. 4, instead of the cross-flow type submodule 2 shown in FIG. 2 and FIG. 3, also promotes the deposition of deposits such as biofilms near the deposition member 22.

Furthermore, as shown in FIG. 1, the membrane separation apparatus of this example includes a dye tank 4, and a flow path extending from the dye tank 4 is connected to the feed water F supply flow path extending to the submodule. Thus, the apparatus is configured to optionally supply a dye together with the feed water F by opening or closing the on-off valve 5 in the flow path from the dye tank 4. Based on the results of this example, it can be said that the deposits (fouling) can be evaluated in the same manner as in this example also when the dye is used. When the dye is used, substances to be stained can be evaluated according to the dye used. Therefore, the substances to be stained can be suitably evaluated.

### DESCRIPTION OF REFERENCE NUMERALS

1: Reverse osmosis membrane module
2: Submodule
3: Imaging system
4: Dye tank
5: On-off valve
6: Pressure pump
21: Submodule outer wall
22: Deposition member
23: Reverse osmosis membrane
24: Permeate side flow path member
25: Transparent window
31: Image processor
32: Light receiving element
33: Pinhole panel
34: Image forming lens
35: Half mirror
36: Objective lens
37: Light source

1. A membrane separation apparatus comprising:
a separation membrane module configured to produce at least a permeate fluid from a feed fluid; and
at least one submodule including a separation membrane made of the same material as a separation membrane in the separation membrane module,
wherein a deposition member is provided on a surface of the separation membrane in the submodule, and the feed fluid is supplied onto the surface.

2. The membrane separation apparatus according to claim 1, further comprising a means of measuring an intensity of light reflected from the submodule.

3. The membrane separation apparatus according to claim 1, wherein the deposition member comprises projections that are in contact with the surface and have a thickness of 0.1 mm or more in a thickness direction of the separation membrane in the submodule.

4. The membrane separation apparatus according to claim 2, wherein the deposition member comprises projections that are in contact with the surface and have a thickness of 0.1 mm or more in a thickness direction of the separation membrane in the submodule.

5. The membrane separation apparatus according to claim 1, wherein the deposition member is a mesh net that entirely covers the surface.

6. The membrane separation apparatus according to claim 2, wherein the deposition member is a mesh net that entirely covers the surface.

7. The membrane separation apparatus according to claim 3, wherein the deposition member is a mesh net that entirely covers the surface.

8. The membrane separation apparatus according to claim 4, wherein the deposition member is a mesh net that entirely covers the surface.

9. An operation method of the membrane separation apparatus according to claim 1, the method comprising accumulating, analyzing, or transmitting and receiving electronic data by using an electronic means, the electronic data being obtained from an imaging system or a data acquisition system provided in the submodule.

10. An evaluation method using the membrane separation apparatus according to claim 1, the method comprising comparatively evaluating fouling in a region adjacent to the deposition member on the surface in the submodule and fouling in a region other than the adjacent region on the surface in the submodule.
